(19) United States
(12) Patent Application Publication
(10) Pub. No.: US 2024/0405876 A1
(43) Pub. Date: Dec. 5, 2024

(54) RAMAN OPTICAL AMPLIFIER, OPTICAL TRANSMISSION SYSTEM, AND METHOD FOR ADJUSTING RAMAN OPTICAL AMPLIFIER

(71) Applicant: Fujitsu Limited, Kawasaki-shi (JP)

(72) Inventor: Takashi SATO, Kawasaki (JP)

(73) Assignee: Fujitsu Limited, Kawasaki-shi (JP)

(21) Appl. No.: 18/657,163

(22) Filed: May 7, 2024

(30) Foreign Application Priority Data
May 31, 2023 (JP) 2023-089860

(51) Int. Cl. H04B 10/291; H01S 3/067; H01S 3/094; H01S 3/10; H01S 3/30

(52) U.S. Cl. CPC H04B 10/2916; H01S 3/06758; H01S 3/094096; H01S 3/1001; H01S 3/302; H01S 2301/04

(57) ABSTRACT

A Raman optical amplifier includes a pumping source configured to include a plurality of laser elements including different wavelengths, the plurality of laser elements being configured as pumping sources including a gain in a wavelength band obtained by adding a first wavelength band in operation and a second wavelength band to be added, wherein a pumping ratio between the plurality of laser elements is adjusted so that a gain spectrum of the Raman optical amplifier becomes flat over the wavelength band obtained by adding the first wavelength band and the second wavelength band.

### CROSS-REFERENCE TO RELATED APPLICATION

This application is based upon and claims the benefit of priority of the prior Japanese Patent Application No. 2023-89860, filed on May 31, 2023, the entire contents of which are incorporated herein by reference.

### FIELD

The embodiment discussed herein is related to a Raman optical amplifier, an optical transmission system, and a method for adjusting a Raman optical amplifier.

### BACKGROUND

In an optical transmission system using a wavelength division multiplexing (WDM) method, a transmission distance and a transmission capacity are increased by compensating for deterioration in an optical signal-to-noise ratio (OSNR) due to an optical loss in an optical fiber of a transmission path. As one of techniques for compensating for the deterioration in the OSNR, there is a Raman optical amplifier. By applying pumping light to the optical fiber of the transmission path, the Raman optical amplifier uses this optical fiber as an amplification medium. Although there are many WDM optical transmission systems that use only a specific wavelength band so far, it is expected that multiband optical transmission using a plurality of wavelength bands becomes mainstream in the future in order to increase the transmission capacity. For example, it is expected that an optical transmission system using only a C-band of 1530 nm to 1565 nm or only an L-band of 1565 nm to 1625 nm is shifted to an optical transmission system using both the C-band and the L-band.

A configuration has been proposed in which, when a new wavelength is amplified, a pumping source of the new wavelength is added and turned on, and at the same time, an output intensity of existing Raman pumping light is changed, and a signal light intensity in an existing band is maintained at a certain level before and after addition of a new band.

Japanese Laid-open Patent Publication No. 2002-303896 is disclosed as related art.

### SUMMARY

According to an aspect of the embodiments, a Raman optical amplifier includes a pumping source configured to include a plurality of laser elements including different wavelengths, the plurality of laser elements being configured as pumping sources including a gain in a wavelength band obtained by adding a first wavelength band in operation and a second wavelength band to be added, wherein a pumping ratio between the plurality of laser elements is adjusted so that a gain spectrum of the Raman optical amplifier becomes flat over the wavelength band obtained by adding the first wavelength band and the second wavelength band.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a schematic diagram of a Raman amplification type optical repeater of the related art before a new band is added;

FIG. 1B is a schematic diagram of the Raman amplification type optical repeater of the related art after the new band is added;

FIG. 2 is a schematic diagram illustrating an example of addition of a new band according to an embodiment;

FIG. 3A is a schematic diagram of pumping light and signal light before an operation of the new band;

FIG. 3B is a schematic diagram of the pumping light and the signal light after the new band is added;

FIG. 4A is a schematic diagram of a Raman optical amplifier according to the embodiment before the new band is added;

FIG. 4B is a schematic diagram of the Raman optical amplifier according to the embodiment after the new band is added;

FIG. 5 is a flowchart of a method for adjusting a Raman optical amplifier according to the embodiment;

FIG. 6 is a schematic diagram of an optical communication system using the Raman optical amplifier according to the embodiment; and

FIG. 7 is a diagram illustrating an example of a pumping ratio table.

### DESCRIPTION OF EMBODIMENTS

When the new band is added, in a case where Raman amplification in the new band is started from an operation state of the existing band, a Raman gain may be generated also in a wavelength range of signal light of the existing band due to a gain spectrum of pumping light of the new band, and a signal error may be caused by a level change of the signal light. To solve this problem, in a known method, a power of pumping light in the L-band to be newly added is increased stepwise while a power of pumping light in the C-band is decreased stepwise. However, an oscillation state of a laser light source for pumping is unstable in a low power region, and a power of the laser light source for pumping fluctuates greatly over time. It is difficult to stably and gradually increase the power of the pumping light in the new band in practice.

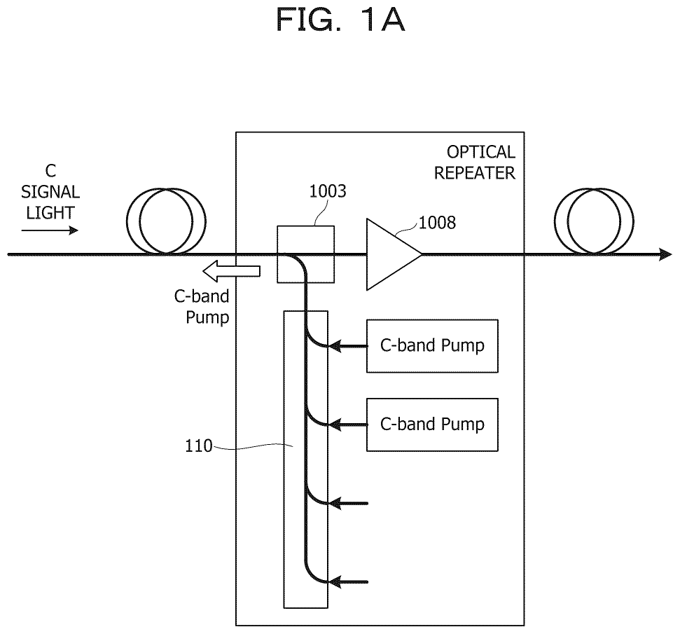

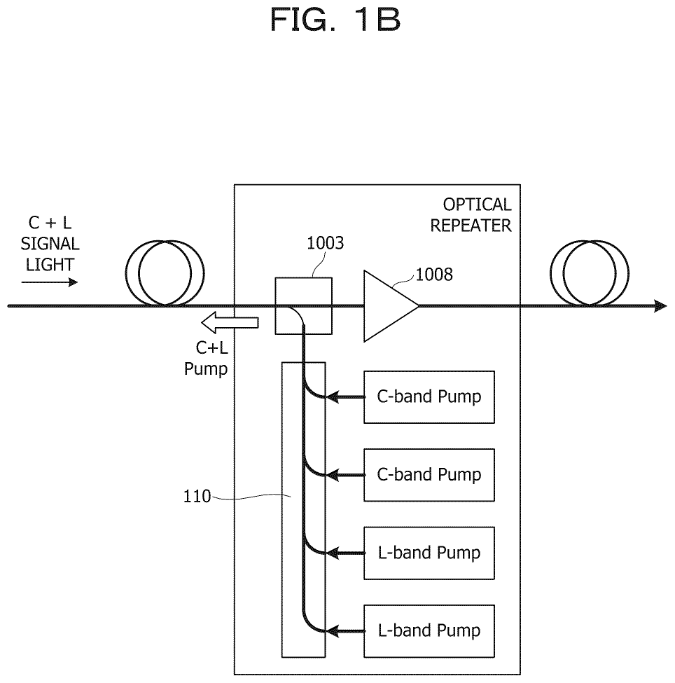

Before describing a specific configuration and method of Raman optical amplification according to an embodiment, a problem when a new band is added in the related art will be described in more detail. FIG. 1A is a schematic diagram of a Raman amplification type optical repeater of the related art before a new band is added, and FIG. 1B is a schematic diagram of the Raman amplification type optical relay after the new band is added. In FIG. 1A, signal light in a C-band is incident on the optical repeater from a transmission path. C-band pumping sources (denoted as “C-band Pumps” in the drawing) including a plurality of laser diodes (LDs) are used in order to Raman-amplify the signal light included in the C-band. Pumping light rays emitted from the C-band pumping sources are multiplexed by a multiplexer 110, and are output to the transmission path by a Raman pumping light multiplexer 1003 in a direction indicated by a white arrow, for example, in a direction opposite to an incident direction of the signal light. In an optical fiber of the transmission path, a Raman gain is generated in a wavelength region corresponding to a wavelength of the pumping light in the C-band, and the C-band signal light is Raman-amplified. The Raman-amplified C-band signal light is incident on the optical repeater, is amplified by a lumped constant type optical amplifier 1008 such as an erbium-doped fiber amplifier (EDFA), and is output to the transmission path on a downstream side.

In FIG. 1B, when an L-band is added, L-band pumping sources (denoted as “L-band Pumps” in the drawing) are added. The C-band pumping light and L-band pumping light are multiplexed by the multiplexer 110, and Raman pumping light that covers the C-band and the L-band is output in a direction opposite to an incident direction of the signal light by the Raman pumping light multiplexer 1003.

A gain spectrum of the L-band pumping light has a peak of a gain in a wavelength range of the L-band, but also has a certain level of gain in a wavelength range of the C-band, and influences a power of the C-band signal light. As described above, in a known method, when the L-band pumping sources are coupled and are started to be driven, a power of the L-band pumping light is increased stepwise while a power of the C-band pumping light is decreased stepwise. However, since an oscillation state of the laser light source becomes unstable in a low power region, the power is not maintained to a desired power, and the power greatly fluctuates at random over time. Thus, when the L-band pumping light is transiently in the low power region, there is a possibility that a symptom in which the Raman gain in the C-band fluctuates over time occurs and a transient error occurs in the signal in the C-band.

According to the embodiment, the existing band is operated in a state where a pumping ratio is adjusted such that a flat gain spectrum is obtained in the entire band obtained by adding the existing band and the new band in anticipation of the addition of the new band in advance. When the new band is added, since the flat gain spectrum is already obtained in the entire band obtained by adding the existing band and the new band, there is almost no influence on the signal light in the existing band. Fine adjustment of the power of the pumping light may be merely performed as desired. Accordingly, a signal error may be suppressed when the new band is added.

Hereinafter, an embodiment of techniques to suppress a signal error when a new band is added will be described with reference to the drawings. A form described below is an example for embodying the technical idea of the present disclosure and is not intended to limit the disclosed contents. Sizes, positional relationships, and the like of constituent elements illustrated in the drawings may be drawn to be exaggerated for easy understanding of the present disclosure. Identical constituent elements or functions are denoted by identical names or reference signs, and redundant description thereof may be omitted.

### EMBODIMENT

### [Addition of New Band]

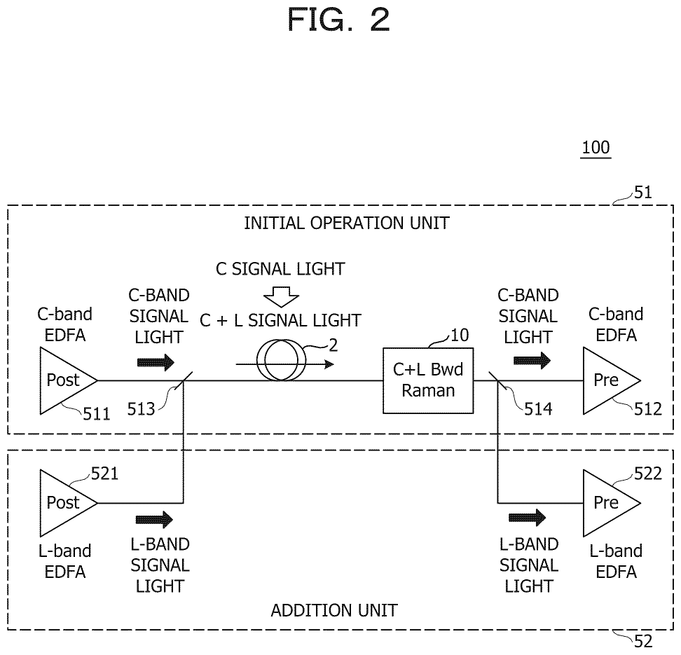

FIG. 2 is a schematic diagram illustrating an example of addition of a new band according to the embodiment. Hereinafter, although the C-band as the existing band (first band), the L-band as the new band (second band), and backward Raman amplification as the Raman amplification will be described as examples, the present disclosure is not limited to these examples. The addition may be addition of an S-band to the C-band, addition of a U-band to the L-band, addition of an E-band to the S-band, or the like. The Raman amplification may be forward Raman amplification or bidirectional Raman amplification.

An optical transmission system 100 includes an initial operation unit 51 and an addition unit 52. In FIG. 2, it is assumed that a left side is an upstream side and a right side is a downstream side. The initial operation unit 51 performs optical communication in the C-band. C-band signal light is amplified by a post-amplifier 511 on the upstream side and is output to a transmission path 2. On the downstream side, the C-band signal light received from the transmission path 2 is amplified by a pre-amplifier 512. A Raman optical amplifier 10 using an optical fiber as an amplification medium is provided on the upstream side or the downstream side of the transmission path 2. In the example illustrated in FIG. 2, the Raman optical amplifier 10 is provided on the downstream side to perform backward Raman pumping. For example, the pumping light is output in a direction opposite to a signal propagation direction for the signal light propagating from the upstream side to the downstream side of the transmission path 2.

As a feature of the optical transmission system 100, at the time of the initial operation, a pumping ratio of the Raman optical amplifier 10 is adjusted such that a flat gain spectrum is obtained in the entire band obtained by adding the C-band and the L-band in anticipation of addition of the L-band in advance. The gain spectrum being “flat” means that fluctuation in gain with respect to a wavelength is equal to or smaller than a predetermined threshold or within a predetermined allowable range. Before the L-band is added, only the C-band signal light propagates through the transmission path 2 in the initial operation unit 51, but a pumping source of the Raman optical amplifier 10 outputs the L-band pumping light together with the C-band pumping light. The C-band signal light is Raman-amplified with a gain obtained by adding a Raman gain generated in the transmission path 2 by the C-band pumping light and a Raman gain generated in the transmission path 2 by the L-band pumping light such that the power spectrum is flat.

Due to the incidence of the C-band pumping light on the optical fiber of the transmission path 2, a peak of the C-band Raman gain is generated on a long wavelength side by a wavelength (about 100 nm) corresponding to the Stokes shift with respect to the wavelength of the C-band pumping light. Due to the incidence of the L-band pumping light, a peak of the L-band Raman gain is generated on the long wavelength side by a wavelength (about 100 nm) corresponding to the Stokes shift with respect to the wavelength of the L-band pumping light. Although a bottom portion of the gain spectrum of the L-band pumping light overlaps a region near the peak of the gain spectrum of the C-band pumping light, the pumping ratio is adjusted such that the gain spectrum is flat in all the pumping light rays in the C-band and the L-band. Accordingly, the Raman-amplified C-band signal light has a flat power spectrum in the entire C-band.

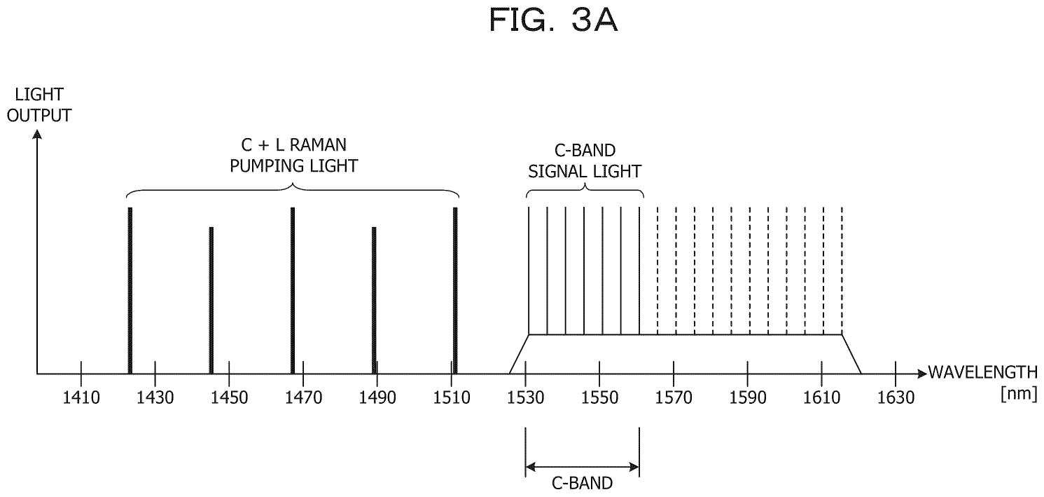

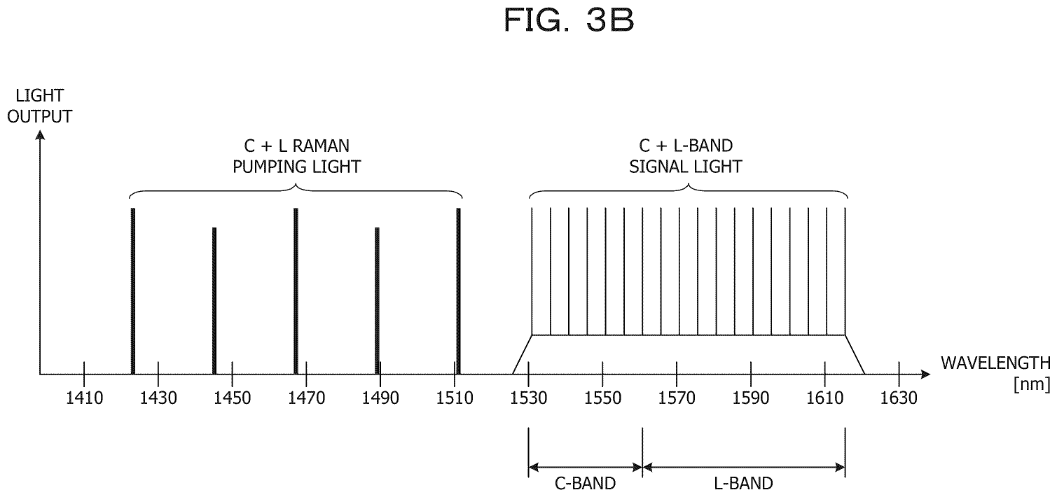

FIG. 3A is a schematic diagram of the pumping light and the signal light before the L-band is added. The pumping source emits pumping light having a wavelength lower than a wavelength of signal light to be amplified by about 100 nm. Before the L-band is added, the signal light to be amplified is only the C-band signal light, but the pumping ratio of the pumping source of the Raman optical amplifier 10 is adjusted such that the gain spectrum is flat in the entire band obtained by adding the C-band and the L-band. As indicated by a plurality of solid lines in the drawing, the C-band signal light includes a large number of wavelength-multiplexed signal light rays. At this stage, since the L-band signal light does not propagate through the transmission path 2, the L-band signal light is indicated by a broken line. The C-band signal light that is Raman-amplified by the gain generated by the C-band pumping light and the L-band pumping light has the flat power spectrum over the entire C-band.

Referring back to FIG. 2, when the addition unit 52 is added, the L-band signal light is output to the transmission path 2 together with the C-band signal light on the upstream side. The L-band signal light is amplified by a post-amplifier 521, is multiplexed with the C-band signal light by a multiplexer 513, and is output to the transmission path 2. Backward Raman pumping is performed on the C-band signal light and the L-band signal light having propagated through the transmission path 2 by the Raman optical amplifier 10 on the downstream side. The Raman-pumped C-band signal light and L-band signal light are demultiplexed by a demultiplexer 514. The demultiplexed C-band signal light and L-band signal light may be amplified by the pre-amplifier 512 and a pre-amplifier 522, respectively.

FIG. 3B is a schematic diagram illustrating the pumping light and the signal light after the L-band is added. Due to the addition of the L-band, the C-band signal light and the L-band signal light are Raman-pumped. Before the L-band is added, the pumping ratio of the pumping source of the Raman optical amplifier 10 is adjusted such that the gain spectrum is flat in the entire band obtained by adding the C-band and the L-band. Accordingly, even after the L-band is added, the signal light has the flat power spectrum over the entire band of the C-band and the L-band.

Unlike the configuration of the related art, in the configuration illustrated in FIG. 2, when the L-band is added, the pumping source for the L-band may not be added, and a power of the C-band pumping light and a power of the L-band pumping light may not be significantly changed. When the C-band is operated, since the pumping ratio is adjusted such that the gain spectrum is flat in the entire band obtained by adding the C-band and the L-band, level fluctuation due to input of the L-band pumping light and a signal error due to instability in a low power region may be suppressed when the L-band is added.

### [Configuration of Raman Optical Amplifier]

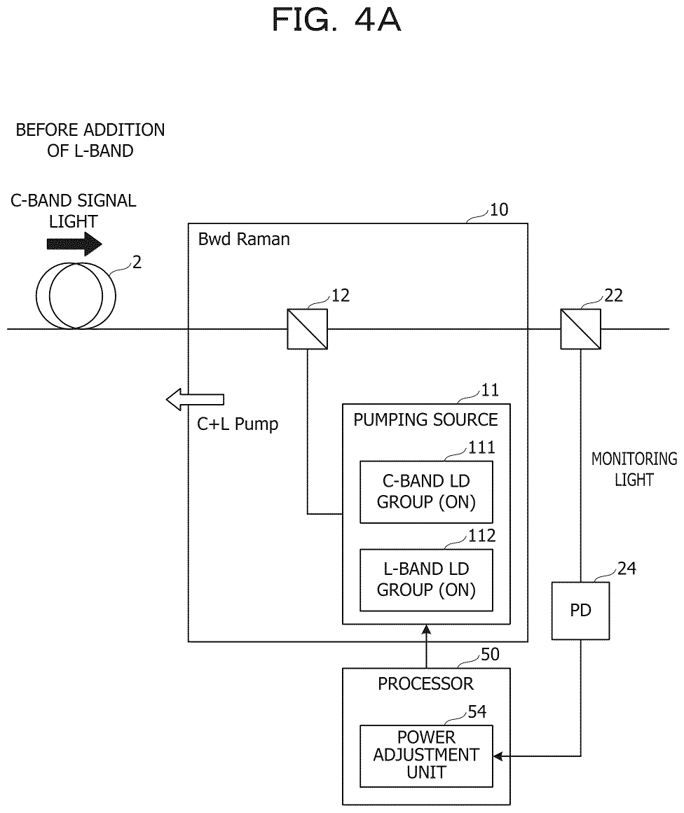

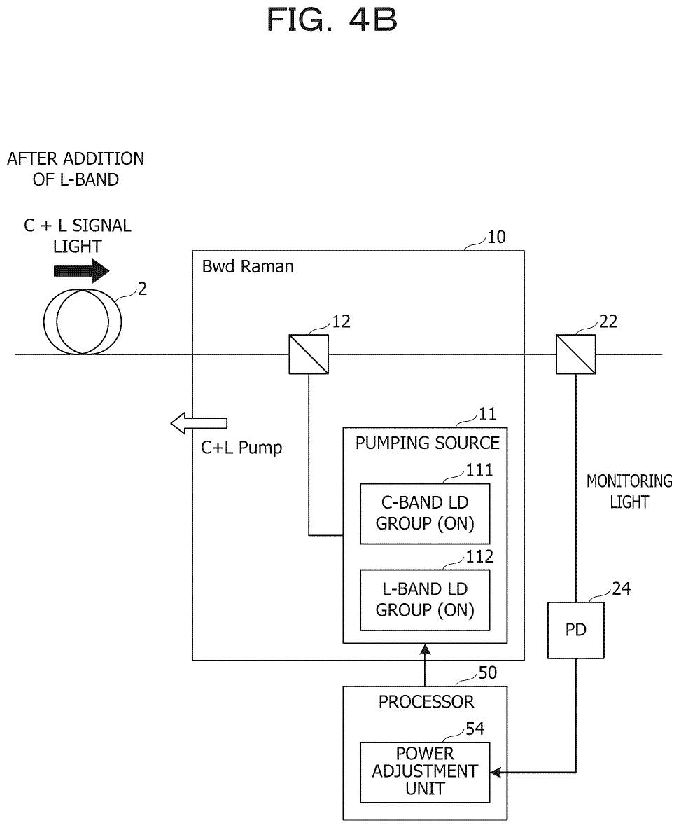

FIG. 4A is a schematic diagram of the Raman optical amplifier 10 before the new band is added, and FIG. 4B is a schematic diagram of the Raman optical amplifier 10 after the new band is added. In FIGS. 4A and 4B, it is assumed that a left side of the paper is an upstream side and a right side is a downstream side. In FIG. 4A, the Raman optical amplifier 10 includes a pumping source 11 and an optical filter 12 that outputs pumping light output from the pumping source 11 toward the upstream side of the transmission path 2. The pumping source 11 includes a C-band LD group 111 and an L-band LD group 112. Each of the C-band LD group 111 and the L-band LD group 112 includes one or more LDs. Each LD of the C-band LD group 111 and each LD of the L-band LD group 112 have different pumping wavelengths. When the C-band is operated, both the C-band LD group 111 and the L-band LD group 112 are turned on.

Before the new band is added, the C-band signal light propagates through the transmission path 2 to the downstream side. The Raman optical amplifier 10 outputs the C-band pumping light and the L-band pumping light toward the upstream side of the transmission path 2. The pumping ratio of the pumping source 11 is adjusted in advance by a processor 50 such that the gain spectrum is flat in the entire band obtained by adding the C-band and the L-band. C-band signal light backward-pumped by the C-band pumping light and the L-band pumping light are transmitted through the optical filter 12 and propagate through the transmission path 2 to the downstream side.

Among the light transmitted through the optical filter 12, a part of the C-band signal light is separated by a coupler 22 and is detected by a photodiode (PD) 24. A detection result of the PD 24 is input to the processor 50. The processor 50 has a power adjustment unit 54 as a part of functions thereof, and adjusts a pumping power of the pumping source 11 such that the power spectrum of the signal light is maintained to be flat based on the detection result. Each of the coupler 22 and the processor 50 may be provided inside the Raman optical amplifier 10, may be provided inside an optical transmission device positioned on the downstream side of the Raman optical amplifier 10, or may be provided as an external device.

As illustrated in FIG. 4B, when the L-band is added, the C-band signal light and the L-band signal light propagate through the transmission path 2 toward the downstream side. As before the addition of the L-band, the Raman optical amplifier 10 outputs the C-band pumping light and the L-band pumping light to the upstream side of the transmission path 2 through the optical filter 12. The pumping ratio of the pumping source 11 is adjusted in advance such that the gain spectrum is flat in the entire band obtained by adding the C-band and the L-band, and power fluctuation due to the input of the pumping light in the new band hardly occurs. The C-band signal light and the L-band signal light which are Raman-pumped by the C-band pumping light and the L-band pumping light are transmitted through the optical filter 12 and propagate through the transmission path 2 toward the downstream side.

A part of the C-band signal light and the L-band signal light transmitted through the optical filter 12 is separated by the coupler 22 and is detected by the photodiode (PD) 24, and the detection result is input to the processor 50. The processor 50 has the power adjustment unit 54 as a part of functions thereof, and adjusts a pumping power of the pumping source 11 such that the power spectrum of the signal light is maintained to be flat based on the detection result. This is because although there is no large level fluctuation of the signal light due to the input of the L-band pumping light, the power of the signal light may fluctuate due to a change in a state of the transmission path 2 or a fluctuation in a loss.

When the existing band is operated, since the pumping ratio is adjusted in the Raman optical amplifier 10 such that the gain spectrum is flat in the entire band obtained by adding the existing band and the new band, the signal error due to the power fluctuation when the new band is added is suppressed.

### [Method of Adjusting Raman Optical Amplifier]

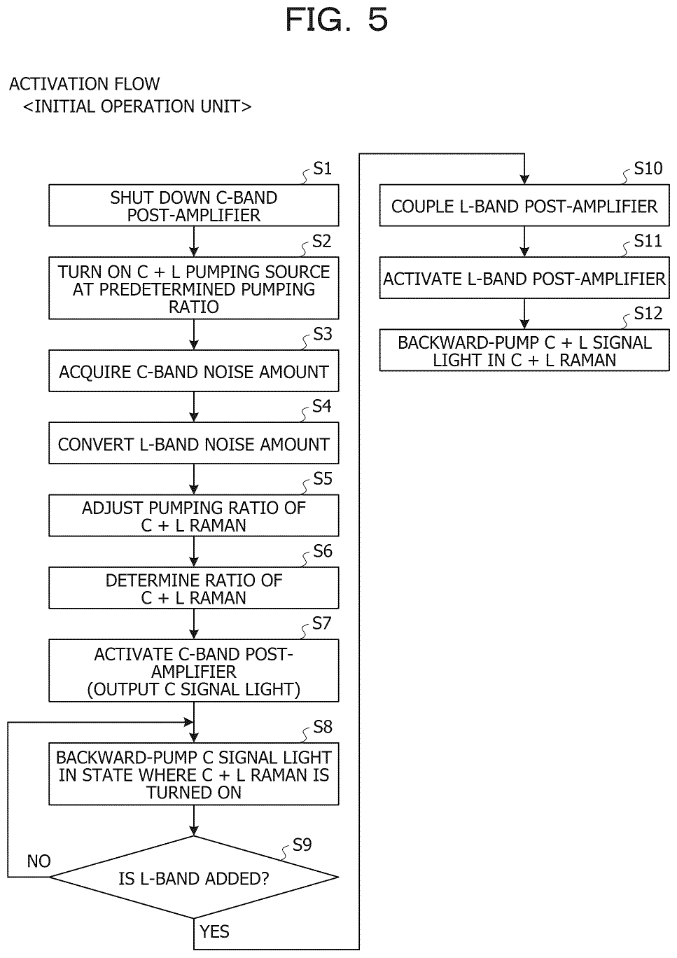

FIG. 5 is a flowchart illustrating an example of a method for adjusting the Raman optical amplifier according to the embodiment. This adjustment flow is executed by the processor 50. Operations S1 to S9 are operations related to the initial operation unit 51 in FIG. 2, and operations S10 to S12 are operations related to the addition unit 52 in FIG. 2. First, when the C-band is operated, the C-band post-amplifier 511 (see FIG. 2) on the upstream side is shut down (S1), and the C-band LD group 111 and the L-band LD group 112 are sequentially turned on at a predetermined pumping ratio (S2). A predetermined pumping ratio is an ideal pumping ratio defined in advance over a predetermined band for each type of an optical fiber used in an optical transmission path. A plurality of LDs included in the pumping source 11 of the Raman optical amplifier 10 are turned on at this ideal pumping ratio.

In a state where there is no signal light in the transmission path 2, a noise amount due to Raman amplification is acquired from the detection result of the PD 24 in a state where the LDs included in the pumping source 11 are sequentially driven (S3). Since the C-band post-amplifier 511 on the upstream side is turned off, a main component of the noise acquired at this time is amplified spontaneous scattering (ASS) noise depending on the pumping light power. The ASS noise in the transmission path 2 is proportional to the Raman gain.

A noise amount in the L-band is converted from a noise amount in the C-band (S4). For example, an L-band noise amount N_{L} is given as a linear function (N_{L}=aN_{C}+b) of a C-band noise amount N_{C}. Coefficients a and b are determined depending on a fiber type and an assumed condition, and as an example, a=0.90 and b=0.12. Calculation of the noise amount in the L-band may be replaced with calculation of the Raman gain in the L-band. After a profile of the Raman gain in the entire band including the C-band and the L-band is obtained, the pumping ratio of the pumping source 11 is adjusted such that this gain profile is substantially flat, for example, such that the fluctuation in the gain over the C-band and the L-band is within an allowable range (S5).

At a point in time when a change in the gain spectrum is flat or within the allowable range in the entire C-band and L-band, the pumping ratio thereof is determined (S6). The determined pumping ratio may be recorded or stored in a memory inside or outside the processor 50. The adjusted pumping ratio is stored, and thus, an optimum pumping ratio for the pumping source 11 may be set when the Raman optical amplifier 10 is restarted.

After the pumping ratio is determined, the C-band post-amplifier 511 on the upstream side is activated and outputs the C-band signal light to the transmission path 2 (S7). The C-band signal light is backward-pumped by the C-band pumping light and the L-band pumping light (S8). At this stage, amplified spontaneous emission (ASE) noise due to the C-band post-amplifier 511 is added to the noise in the transmission path 2, but this ASE noise may be stored, as a known value, in the processor 50 in advance, and a signal light power may be obtained by subtracting the ASE noise from a power of received signal light to be monitored.

Due to the state change or the loss fluctuation in the transmission path 2, the signal light power fluctuates. Based on the detection result of the PD 24 and the known ASE noise, the pumping power of each LD of the pumping source 11 is finely adjusted such that the flatness of the power spectrum of the signal light is maintained. Until the L-band is added, the operation in the C-band is continued by using the C-band pumping light and the L-band pumping light.

During the operation in the C-band, when the L-band is added (YES in S9), the L-band post-amplifier 521 is coupled to the upstream side (S10). After the post-amplifier 521 is activated (S11), the C-band signal light and the L-band signal light are output to the transmission path 2. The Raman optical amplifier 10 backward-pumps the C-band signal light and the L-band signal light with the C-band pumping light and the L-band pumping light for which the pumping ratio is already adjusted (S12). Operation S12 is executed while communication in the C-band and the L-band continues.

The processing flow in FIG. 5 is applicable to a case where the existing band and the addition band are other than the C-band and the L-band, and is also applicable to a case of bidirectional pumping or forward pumping. For example, in a case where the S-band is added to the C-band, the pumping ratio of the Raman pumping source is adjusted such that the flat gain spectrum is obtained over the entire band of the C-band and the S-band when the C-band is operated. In the case of the forward pumping, the post-amplifiers 511 and 521 on the upstream side and the amplifiers on the downstream side are turned off, and a LD group of a forward Raman amplifier provided on the upstream side is sequentially turned on. The ASS noise at each pumping wavelength of the existing band and the band to be added is acquired based on the detection result of the PD provided on the downstream side. A pumping ratio of the forward Raman amplifier is adjusted such that the gain spectrum is flat in the entire band obtained by adding the existing band and the band to be added.

### [Configuration Example of Optical Transmission System]

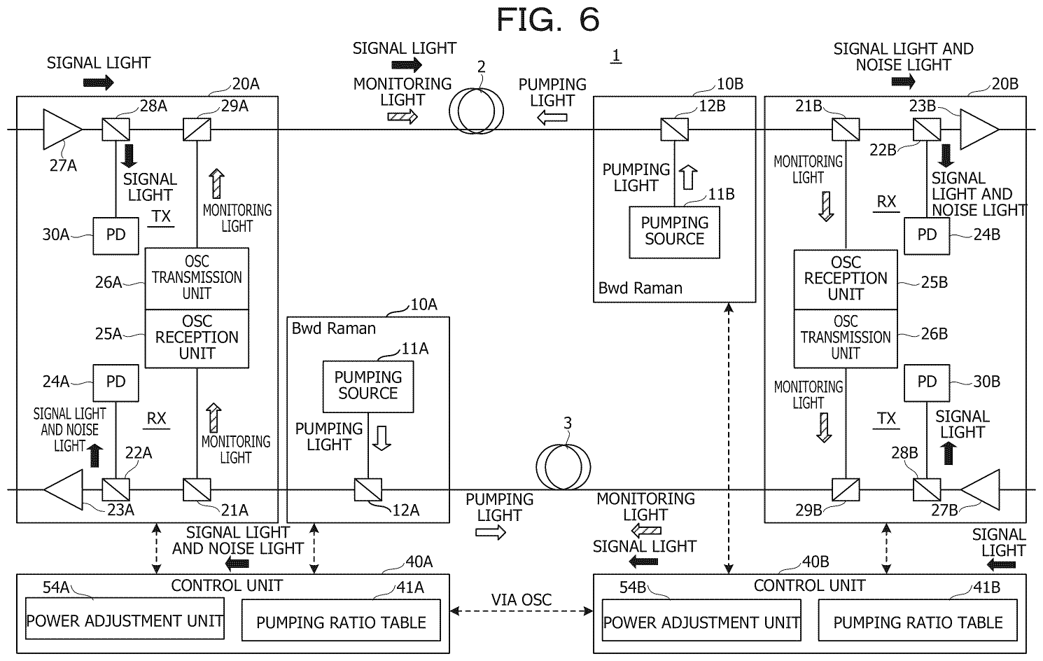

FIG. 6 is a schematic diagram of an optical transmission system 1 using the Raman optical amplifier 10 according to the embodiment. The optical transmission system 1 includes optical transmission devices 20A and 20B coupled to each other by transmission paths 2 and 3. Each of the optical transmission devices 20A and 20B may be an optical repeater that amplifies signal light or an optical add-drop multiplexer (OADM) that selectively adds or separates signals having desired wavelengths included in a predetermined wavelength band.

On the transmission path 2, in a case where the signal light propagates from the optical transmission device 20A toward the optical transmission device 20B, the optical transmission device 20A is a device on the upstream side. A Raman optical amplifier 10B is disposed in front of the optical transmission device 20B on the downstream side. On the transmission path 3, in a case where the signal light propagates from the optical transmission device 20B to the optical transmission device 20A, the optical transmission device 20B is a device on the upstream side, and a Raman optical amplifier 10A is disposed in front of the optical transmission device 20A.

The optical transmission device 20A and the Raman optical amplifier 10A are coupled to a control unit 40A. The control unit 40A is realized by the processor 50 and controls operations of the optical transmission device 20A and the Raman optical amplifier 10A. The optical transmission device 20B and the Raman optical amplifier 10B are coupled to a control unit 40B. The control unit 40B is realized by the processor 50 and controls operations of the optical transmission device 20B and the Raman optical amplifier 10B. Assuming that the optical transmission device 20A and the 20B have the same configuration, the operation will be described by focusing on the transmission path 2. On the transmission path 3, the same operation is performed in a direction opposite to that of the transmission path 2.

The optical transmission device 20A includes, in a transmission section TX, an optical supervisory channel (OSC) transmission unit 26A, an amplifier 27A, a coupler 28A, an optical filter 29A, and a PD 30A. The amplifier 27A is a lumped constant type amplifier such as an EDFA. In a case where the optical transmission device 20A is an OADM, the amplifier 27A is a post-amplifier that amplifies signal light after wavelength-selection processing, before the signal light is output to the transmission path 2. A part of the signal light may be separated by the coupler 28A, is detected by the PD 30A, and is used for wavelength-selection processing or the like.

The OSC transmission unit 26A generates and outputs monitoring light. The monitoring light is multiplexed with the signal light by the optical filter 29A, and the multiplexed signal light is output to the transmission path 2. The monitoring light may be transmitted by using a part of channels included in the band of the signal light. The signal light and the monitoring light are backward-pumped by the Raman optical amplifier 10B on the downstream side of the transmission path 2. The backward-pumped signal light and monitoring light are transmitted through an optical filter 12B and are received by a reception section RX of the optical transmission device 20B.

The optical transmission device 20B includes, in the reception section RX thereof, an optical filter 21B, a coupler 22B, a PD 24B, an OSC reception unit 25B, and an amplifier 23B. Among the signal light and the monitoring light received from the transmission path 2 by the optical transmission device 20B, the monitoring light is separated by the optical filter 21B and is incident on the OSC reception unit 25B, and monitoring information is extracted. A part of the signal light and noise light transmitted through the optical filter 21B is split by the coupler 22B and is detected by the PD 24B. A detection result of the PD 24B is supplied to the control unit 40B.

The signal light transmitted through the coupler 22B is amplified by the amplifier 23B and is sent to the downstream side. The amplifier 23B is a lumped constant type amplifier such as an EDFA. For example, in a case where the optical transmission device 20B is an OADM, the amplifier 23B may be used as a pre-amplifier that amplifies signal light before wavelength-selection processing.

The control unit 40B includes a pumping ratio table 41B and a power adjustment unit 54B. The control unit 40B selects a pumping ratio to be set for a pumping source 11B based on the pumping ratio table 41B when the Raman optical amplifier 10B is activated. By the method illustrated in FIG. 5, the power adjustment unit 54B adjusts the pumping ratio of the pumping source 11B such that the gain spectrum is flat over the entire band including the existing band and the new band to be added in future.

A transmission section TX of the optical transmission device 20B has the same configuration as the transmission section TX of the optical transmission device 20A. When the Raman optical amplifier 10B is activated, an OSC transmission unit 26B generates monitoring light including an instruction to shut down the amplifier 27A of the optical transmission device 20A based on the control of the control unit 40B. The monitoring light is multiplexed with the signal light traveling toward the optical transmission device 20A by an optical filter 29B and is output to the transmission path 3.

Upon receiving a shutdown completion notification of the amplifier 27A from the optical transmission device 20A, the OSC reception unit 25B notifies the control unit 40B of shutdown completion. The power adjustment unit 54B sequentially turns on the LDs included in the pumping source 11B of the Raman optical amplifier 10B, measures the ASS noise in the transmission path 2, and adjusts the pumping ratio described above. Upon completing the adjustment of the pumping ratio when the Raman optical amplifier 10B is activated, the control unit 40B controls the OSC transmission unit 26B to output monitoring light including an instruction to turn on the amplifier 27A of the optical transmission device 20A. During the operation in the existing band and after the addition of the new band, the control unit 40B finely adjusts the pumping power of the pumping source 11B based on the detection result of the PD 24B.

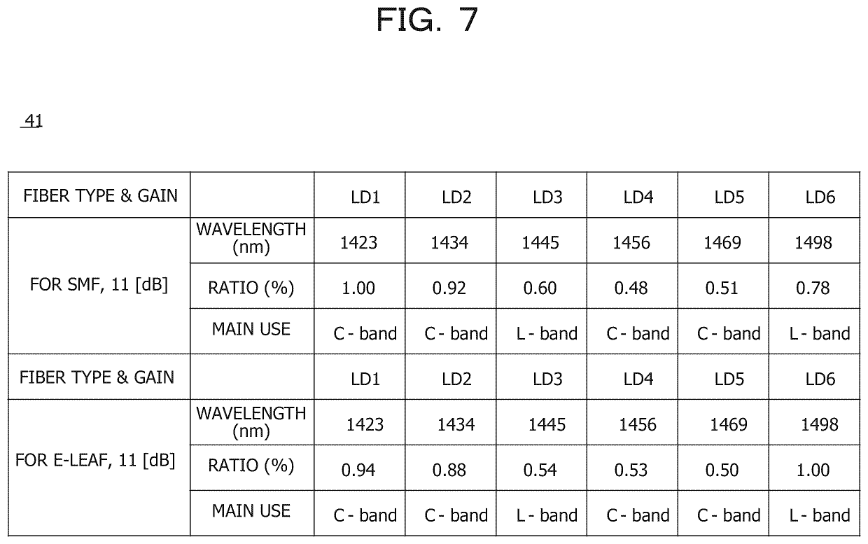

FIG. 7 illustrates an example of a pumping ratio table 41. For each of the types of the optical fibers used for the transmission paths 2 and 3, the pumping ratio table 41 records power ratios of the plurality of LDs of the pumping source 11 in accordance with gain characteristics of the transmission paths. Although a single-mode fiber (SMF) and a LEAF (registered trademark) fiber are exemplified as the fiber type, the fiber type is not limited to this example. The gain characteristic of the transmission path is represented by, for example, an average Raman gain of the transmission path. The average Raman gain is a simple average of the Raman gains generated in the transmission path 2 by the pumping light rays of the plurality of LDs included in the pumping source 11B.

In a case where the pumping source 11B of the Raman optical amplifier 10B includes n LDs, a power ratio of each LD is defined with a maximum power among LD1 to LDn as 1. As described above, the pumping ratio recorded in the pumping ratio table 41 is an ideal or optimum ratio determined by the type of the optical fiber of the transmission path and the average Raman gain, and is used as an initial setting ratio when the Raman optical amplifier 10B is activated. Although a mainly used band is designated as a main use of each LD, other bands may also be influenced. For example, a gain of the LD3 influences the C-band, and a gain of the LD5 influences the L-band.

In a pumping ratio table of the related art, a pumping ratio between as many LDs as the number of LDs that cover one communication band is described. However, in the pumping ratio table 41 according to the embodiment, an optimum pumping ratio over the entire band of the existing band and the new band to be added is described as setting information in the anticipation of the addition of the new band in advance.

As described above, the Raman optical amplifier 10 including the pumping source 11 including the plurality of LDs has the pumping band obtained by adding the existing band in operation and the new band to be added in future, and the pumping ratio between the plurality of LDs is adjusted such that the gain spectrum is flat over the wavelength band obtained by adding the existing band and the new band. During the operation of the existing band, the plurality of LDs are driven to amplify the signal light in the existing band with the pumping light having the flat gain spectrum over the existing band and the new band. Accordingly, when the new band is added, the signal error due to the level change of the signal light may be suppressed. The same applies to the transmission path 3. At the time of activating the Raman optical amplifier 10A in the existing band, the pumping ratio is adjusted by the control unit 40A such that a flat gain spectrum is obtained over the entire existing band and new band. During the operation of the existing band, the signal light in the existing band is amplified by the pumping light having the flat gain spectrum over the entire wavelength band obtained by adding the existing band and the new band. When the new band is added, the signal error due to the level change of the signal light may be suppressed.

Pieces of pumping ratio setting information which are included in the control units 40A and 40B in advance may not be described in a table format. When the Raman optical amplifier 10 is activated in the existing band in operation, as long as an ideal pumping ratio at which the flat gain spectrum is obtained over the entire band of the existing band and the new band to be added may be recognized for each fiber type or for each average gain, the ideal pumping ratio may be described in a function or another format. After the pumping ratio is adjusted by the control unit 40A or 40B, the adjusted pumping ratio may be recorded or stored.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A Raman optical amplifier comprising:
a pumping source configured to include a plurality of laser elements including different wavelengths, the plurality of laser elements being configured as pumping sources including a gain in a wavelength band obtained by adding a first wavelength band in operation and a second wavelength band to be added,
wherein a pumping ratio between the plurality of laser elements is adjusted so that a gain spectrum of the Raman optical amplifier becomes flat over the wavelength band obtained by adding the first wavelength band and the second wavelength band.

2. The Raman optical amplifier according to claim 1, wherein, when the second wavelength band is added, the Raman optical amplifier amplifies first-band signal light and second-band signal light that propagate through the transmission line with pumping light in the wavelength band obtained by adding the first wavelength band and the second wavelength band.

3. An optical transmission system comprising:
a Raman optical amplifier arranged in a transmission line and configured to include a pumping source that includes a plurality of laser elements including different wavelengths, the plurality of laser elements being configured as pumping sources including a gain in a wavelength band obtained by adding a first wavelength band in operation and a second wavelength band to be added,
wherein a pumping ratio between the plurality of laser elements is adjusted so that a gain spectrum of the Raman optical amplifier becomes flat over the wavelength band obtained by adding the first wavelength band and the second wavelength band; and
a processor configured to control the Raman optical amplifier.

4. The optical transmission system according to claim 3, wherein the Raman optical amplifier amplifies first-band signal light and second-band signal light that propagate through the transmission line with pumping light in the wavelength band obtained by adding the first wavelength band and the second wavelength band when the second wavelength band is added.

5. The optical transmission system according to claim 3,
wherein the processor includes pumping ratio setting information in which the pumping ratio in the wavelength band obtained by adding the first wavelength band and the second wavelength band is recoded in association with one of a fiber type of the transmission line and an average Raman gain of the transmission line, and
wherein, when the Raman optical amplifier is activated, the processor adjusts the pumping ratio of the Raman optical amplifier by using the pumping ratio setting information.

6. The optical transmission system according to claim 5, wherein the processor stores the adjusted pumping ratio.

7. A method for adjusting a Raman optical amplifier comprising:
adjusting a pumping ratio between a plurality of laser elements configured as pumping sources including a gain in a wavelength band obtained by adding the first wavelength band in operation and the second wavelength band to be added, so that a gain spectrum of the Raman optical amplifier becomes flat over the wavelength band obtained by adding the first wavelength band and the second wavelength band, a pumping source of the pumping sources including the plurality of laser elements including different wavelengths.

8. The method for adjusting Raman optical amplifier according to claim 7, wherein, when the second wavelength band is added, the Raman optical amplifier amplifies first-band signal light and second-band signal light that propagate through the transmission line with pumping light in the wavelength band obtained by adding the first wavelength band and the second wavelength band.
